(19) United States
(12) Patent Application Publication
(10) Pub. No.: US 2011/0073067 A1
(43) Pub. Date: Mar. 31, 2011

(54) Method for starting a self-igniting internal combustion engine at low temperatures

(76) Inventors: Thomas Koch, Böblingen (DE); Johannes Ritzinger, Stuttgart (DE)

(21) Appl. No.: 12/924,937

(22) Filed: Oct. 8, 2010

Related U.S. Application Data
(63) Continuation-in-part of application No. PCT/EP2009/002898, filed on Apr. 21, 2009.

(30) Foreign Application Priority Data
Apr. 22, 2008 (DE) 10 2008 020 221.5

(51) Int. Cl. F02B 17/00; F02B 3/00

(52) U.S. Cl. 123/295; 123/299

(57) ABSTRACT

In a method for starting a self-igniting internal combustion engine at low temperatures, a first fuel amount is injected into the combustion chamber during a compression stroke of the internal combustion engine by a fuel pre-injection, so as to form a partially homogenous pre-mixture in the combustion chamber; a main fuel amount is then injected into the combustion chamber during a main injection and the fuel/air mixture is combusted by self-ignition, the injection start of the pre-injection being selected such that the partially homogenous pre-mixture can be ignited after a very short ignition delay, and an injection start of the main injection is selected such that the main fuel amount is injected into the combustion chamber either during a combustion phase or directly after a combustion phase of the ignited pre-injection mixture

This is a Continuation-In-Part Application of pending international patent application PCT/EP2009/002898 filed Apr. 21, 2009 and claiming the priority of German patent Application 10 2008 020 221.5 filed Apr. 22, 2008.

### BACKGROUND OF THE INVENTION

The invention relates to a method for starting a self-igniting internal combustion engine at low temperatures, in which initially a first fuel amount is injected into the combustion chamber during a compression stroke of the internal combustion engine and a partially homogeneous pre-mixture is formed. A main fuel amount is injected into the combustion chamber in a subsequent step and the fuel-air mixture is combusted by self-ignition.

From DE 10 2004 053 748 A1, a method for starting a self-igniting internal combustion engine at low temperatures is known, in which fuel is injected into a combustion chamber of the internal combustion engine in three partial injections. A first fuel amount is injected in a pre-injection device, when the piston is in a lower dead center position ahead of compression stroke. A main fuel amount is injected into the combustion chamber in a main injection step, carried out in the region of the upper dead center position of the piston. An after-injection directly follows the main injection, by means of which a better energy conversion is to be achieved. A misfiring during a cold start phase shall be avoided by the method.

JP 2000 192 836 A discloses a further method for starting a self-igniting internal combustion engine at low temperatures, in which a small first fuel amount is injected into a combustion chamber, so that a pre-mixture is formed. It is monitored by means of a suitable sensor system if the pre-mixture ignites. The steps are repeated in the following working cycles until a self-ignition of the first fuel amount is determined. A main fuel amount is subsequently injected into the combustion chamber, whereby a mixture formed of the main fuel amount and air is then safely ignited. A pre-injection and a main injection can thereby be carried out during a working cycle or during successive working cycles of the internal combustion engine in the combustion chamber.

It is the object of the present invention to provide an improved method for starting an internal combustion engine which is distinguished by a safe and fast start at low temperatures.

### SUMMARY OF THE INVENTION

In a method for starting a self-igniting internal combustion engine at low temperatures, a first fuel amount is injected into the combustion chamber during a compression stroke of the internal combustion engine by a fuel pre-injection, so as to form a partially homogenous pre-mixture in the combustion chamber;

a main fuel amount is then injected into the combustion chamber during a main injection and the fuel/air mixture is combusted by self-ignition, the injection start of the pre-injection being selected such that the partially homogenous pre-mixture can be ignited after a very short ignition delay, and an injection start of the main injection is selected such that the main fuel amount is injected into the combustion chamber either during a combustion phase or directly after a combustion phase of the ignited pre-injection mixture.

During the compression stroke, a gas present in the combustion chamber is compressed, whereby a combustion chamber temperature increases. The first fuel amount is injected into this compressed gas by means of a pre-injection. At low ambient temperatures, the temperature in the combustion chamber is too low for a forms in the combustion chamber. With the method according to the invention, the first fuel amount is injected into the combustion chamber at a time where the temperature in the combustion chamber is sufficiently high due to the compression so that the formed partial homogeneous pre-mixture reacts in a typical partial homogeneous combustion at increased temperature after a short ignition delay. Exemplary values for a short ignition delay are time spans of 1 ms to 15 ms between the injection start of the first pre-injection and the reaching of a clearly increased temperature in the combustion chamber (for example 100° K or more above the combustion chamber temperature immediately prior to the injection start). The given time span can be converted to a corresponding crankshaft angle in dependence on the speed of the internal combustion engine. The injection start main injection is further chosen so that the main fuel amount is injected into the combustion chamber during, or immediately after, a combustion phase of the pre-mixture. At this time, a temperature level in the combustion chamber is still clearly increased due to the reaction of the pre-mixture, so that an ignition of the fuel air mixture formed with the main fuel amount is simplified.

In one embodiment of the method, the pre-ignition is carried out in a region between 22° and 100°, in particular between 25° and 30° of the crankshaft angle before an upper dead center of the piston. By means of the late injection in the compression phase into the comparatively warm, compacted air at this time or into the fuel air mixture into the combustion engine, a short ignition delay is ensured. Furthermore, a sufficient time span is available for the partial homogeneous combustion of the pre-mixture at a high temperature, so that a clear temperature increase can be achieved in the combustion chamber.

In a further embodiment of the method, the main injection is carried out in a region between 20° of the crankshaft angle before the upper dead center and 20° of the crankshaft angle after the upper dead center of the piston. In this region, the temperatures in the combustion chamber highest by the maximum compression of the combustion chamber gases and by the advanced heat released from the reaction of the pre-mixture, so that also the probability of an ignition and combustion of the main fuel amount is highest.

In a further arrangement of the method, the main injection is divided into several partial injections, that is, the main fuel amount is injected into the combustion chamber in several partial injections. An injection of fuel into the combustion chamber and a following evaporation leads to a short-term temperature reduction in the combustion chamber in an intrinsic manner, whereby the ignition is delayed. The subdivision of the main injection into several partial injections results in a comparatively low temperature reduction with each partial injection and thereby a shorter ignition delay and a reliable temperature increase.

In a further embodiment of the method, a first partial injection in a region between 2° of the crankshaft angle before the upper dead center and 2° after the top dead center is carried out a the beginning of the starting process, and a second partial injection is carried out in a region between 2° and 5° of the crankshaft angle after the top dead center. Under these conditions, a sufficient time span for a reaction of the fuel amount, which is injected with the first partial injection, is given in particular at low temperatures and/or speeds. The initiation of the starting process or a first ignition of the fuel air mixture is in particular improved with this procedure of the method.

In a further embodiment of the method, an injection start of the first initial injection is advanced with increasing engine speed. In this manner, a temperature increase due to the reaction of the pre-mixture can be utilized in an optimum manner.

In a further embodiment of the method, an injection start of a second and/or of a later partial injection is retarded with increasing speed, so that a time span between the end of a previous partial injection and the start of the second and/or later partial injection is sufficiently large to ensure a lasting temperature increase.

In a further embodiment of the method, a fuel amount injected as a second and/or later partial injection is larger than a fuel amount injected with a previous partial injection. Thus, ever larger amounts of fuel are successively injected into the combustion chamber during the main injection. The stability of the starting process can be improved further in this manner.

In a further embodiment of the method, further pre-injections are carried out. The combustion chamber temperature can thereby also be increased incrementally in the pre-injection phase, so that a stable starting process is possible.

Preferably, the sum of the fuel amounts injected during one or several pre-injections comprises between 5 and 20 weight percent of the entire fuel amount injected in a cylinder during a working cycle. A heating of the combustion chamber by the reaction of the pre-mixture is sufficiently high with these amount ratios, to enable a safe combustion of the main fuel amount.

An injection start of the pre-injection may be advanced with an increasing speed, that is, the pre-injection is carried out at an earlier crankshaft angle. A sufficient time span for the reaction of the pre-mixture and for reaching a lasting temperature increase in the combustion chamber is thereby also achieved even with increasing speeds.

Generally, the injection is carried out by means of a common rail injection system. This injection system offers the necessary variability in order to control or to regulate the injection times, injection durations and injection amounts of the fuel in the individual injections as much as possible.

The injection pressure during the starting process is adjusted in dependence on the speed of the internal combustion engine, in order to provide for an optimum atomization of the fuel and/or to minimize wall wetting of the combustion chamber.

The amount ratio between the main fuel amount and the sum of the partial fuel amounts injected during the pre-injections is adjusted in dependence on the speed and/or the temperature of the internal combustion engine, whereby the cold start properties of the internal combustion engine can be improved further.

The invention will become more readily apparent from the following description of a preferred embodiment thereof on the basis readily apparent from the accompanying drawings.

### BRIEF DESCRIPTION OF THE DRAWINGS

It is shown in:

FIG. 1 a depiction of an injection process and a heating process in a combustion chamber above a crankshaft angle; and

FIG. 2 a depiction of an ignition delay and ignition times over a speed of the internal combustion engine in an exemplary manner.

### DESCRIPTION OF PARTICULAR EMBODIMENTS

An internal combustion engine not shown in the figures is a Diesel engine with six combustion chambers in this embodiment. The internal combustion engine comprises a common rail fuel injection system, which initiates a time-wise precise injection of a defined fuel amount into the individual combustion chambers possible. The internal combustion engine further includes an angle sensor for measuring a crankshaft angle and a control device, with the help of which the common rail injection system can be controlled in dependence on the measured crankshaft angle and possibly on further several operating variables of the internal combustion engine such as temperature, speed, load requirement.

During a starting process of the internal combustion engine, a crankshaft of the internal combustion engine is first rotated by means of a starting device. The crankshaft is connected by connecting rods to pistons disposed in the individual cylinders, so that an oscillating stroke movement is initiated by the rotation of the crankshaft.

A cold start in the sense of the present invention is present when a temperature relevant for the operation of the internal combustion engine is so low that a reliable start is difficult. An ambient temperature and/or a coolant temperature of −15° C. or less is viewed as guideline.

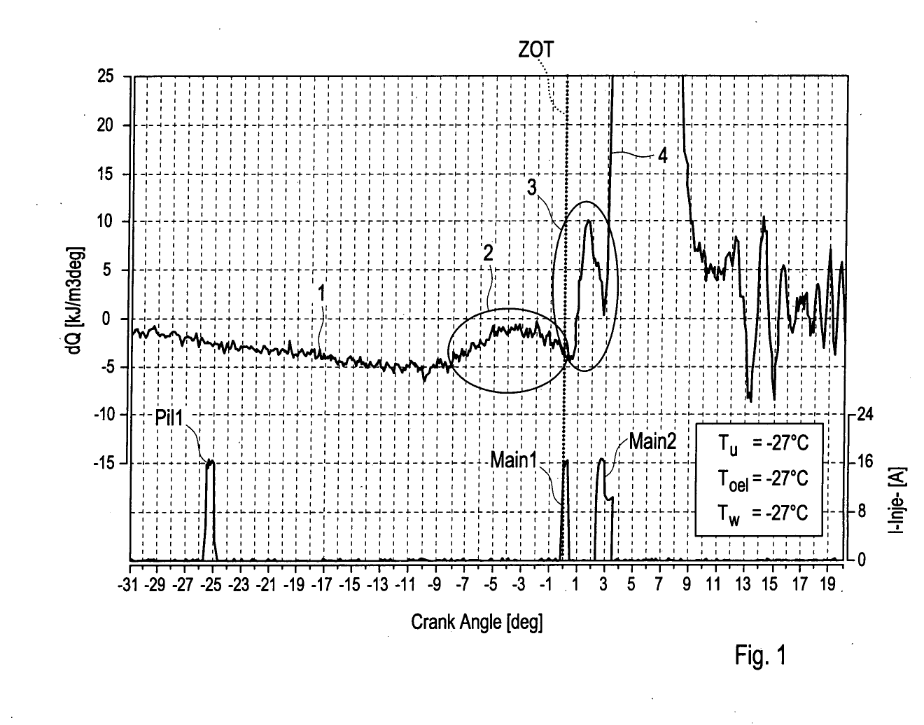

In the lower part of FIG. 1 a control signal of a fuel injector of the internal combustion engine during a cold start of the internal combustion engine is shown in an exemplary manner. At least one injector is assigned to each combustion chamber. The injector preferably comprises a magnetic valve, via which a nozzle needle in a multiple-hole nozzle can be controlled by a control unit. The control signal shown in FIG. 1 can be transmitted to the magnetic valve by the control unit for an adjustment of the stroke off the nozzle needle in the multiple-hole nozzle. A precise dosing of the fuel injected into the combustion chamber is possible in this manner. The injectors of the internal combustion engine assigned to the remaining five combustion chambers are controlled corresponding to the ignition sequence of the six cylinder Diesel engine in an analogous manner with a crankshaft angle spacing distance of 0°, 120° and 240°.

From the depiction of the control signal in FIG. 1 it becomes clear that the entire fuel amount is injected into the combustion chamber in the region of an upper ignition dead center ZOT of the internal combustion engine. With this embodiment, a first fuel amount is injected into the combustion chamber in a pre-injection step Pil1 during a compression cycle at a crankshaft angle at about −25°, that is, before the upper ignition dead center ZOT. The first fuel amount is preferably between one and thirty milligram, which corresponds to about five to twenty percent of the entire fuel amount injected during the working cycle.

A main fuel amount is subsequently injected into the combustion chamber in the main injection. The main injection is subdivided into a first partial injection Main1 and a second partial injection Main2. The first partial injection Main1 takes place at a crankshaft angle of around 0°. The second partial injection Main2 starts at a distance of around 1.5° of the crankshaft angle after completing the first partial injection Main1 and extends to a crankshaft angle of around 3.5° after the upper dead center ZOT.

In the upper part of FIG. 1 a heating process in the combustion chamber in the region of the upper dead center ZOT is shown. The negative gradient of the heating process that can be seen from the upper dead center ZOT can mainly be ascribed to heat losses by a heat transfer to the combustion chamber walls. The heating process was measured at an ambient temperature of −27° C.

By means of the injection of the first fuel amount Pil1 at a crankshaft angle of about −25°, a partial homogeneous mixture is formed in the combustion chamber. The injected first fuel amount evaporated during the injection, whereby a small decrease of the combustion chamber temperature results initially (seen in FIG. 1 by the slightly flattened gradient of the heating process behind the pre-injection Pil1). At the time of the pre-injection Pil1, the temperature in the combustion chamber is however too low for a conventional diffusion combustion, so that the pre-mixture formed with the first fuel amount reacts in a typical partial homogeneous combustion. During the homogenization, the pre-mixture is heated by heat conduction and a turbulent flow in the combustion chamber and due to the advanced compression. In a first reaction phase 1, which extends in this embodiment from about −25° to about −9° of the crankshaft angle and which is also called low temperature phase, pre-reactions take place, in which peroxides and aldehydes are essentially formed and degenerate, wherein only small heat amounts are released. In a subsequent second reaction phase 2, which extends from about −9° to about 0° of the crankshaft angle and is also called high temperature phase, a thermal ignition of the fuel air mixture takes place, so that the actual heat release from the reaction of the pre-mixture takes place here. The first reaction phase 1 and the second reaction phase 2 together form a combustion phase of the pre-mixture.

The main fuel amount is injected into the combustion chamber in a main injection Main1, Main2 at a time when a part of the pre-mixture is combusted in the second reaction phase 2, so that a clearly increased temperature is present in the combustion chamber at this time. From FIG. 1 can be seen that the fuel air mixture formed with the first partial injection Main 1 reacts chemically in a third reaction phase 3 and combusts. An ignition delay between the injection start of the first partial injection Main1 and the start of the thermal ignition is thereby clearly shorter than the ignition delay with the reaction of the pre-mixture. Due to the higher temperature in the combustion chamber, the fuel air mixture formed after the first partial injection Main1 evaporates faster, and it already ignites at 1° of the crankshaft angle after the upper dead center ZOT, whereby the temperature in the combustion chamber increases further. Subsequently, a comparatively large fuel amount is injected into the heated combustion chamber in a second partial injection Main 2, which ignites virtually immediately after the injection start in a fourth reaction phase 4 due to the high temperature.

The fuel amount injected during the second partial injection Main2 is preferably larger than the fuel amount injected during the first partial injection Main1, whereby the effects of the evaporations on the combustion chamber temperature and thus on the ignition delay are attenuated. The fuel amount injected during the first partial injection is relatively small, so that the combustion chamber temperature is marginally reduced after the evaporation. By means of the energy released during the combustion of the fuel air mixture, the temperature reduction due to the evaporation is compensated and the combustion chamber temperature is increased. The higher temperature results in a shorter ignition delay of the fuel amount subsequently injected in the second partial injection.

In a modified embodiment, the main injection is divided into further partial injections, wherein a larger fuel amount than in a previous partial injection is preferably injected into the combustion chamber with each partial injection. In this manner, relatively large fuel amounts can altogether be combusted safely at low temperatures.

In a further modified embodiment, further pre-injections are provided, wherein lower temperature decreases and shorter ignition delays occur after each pre-injection, so that a faster temperature increase and a faster reaction of the pre-mixture is achieved.

The pre-injection and the main injection can be carried out during a cold start during several compression cycles. It has to be considered thereby that a first ignition possibly only takes place after a few crankshaft angle rotations.

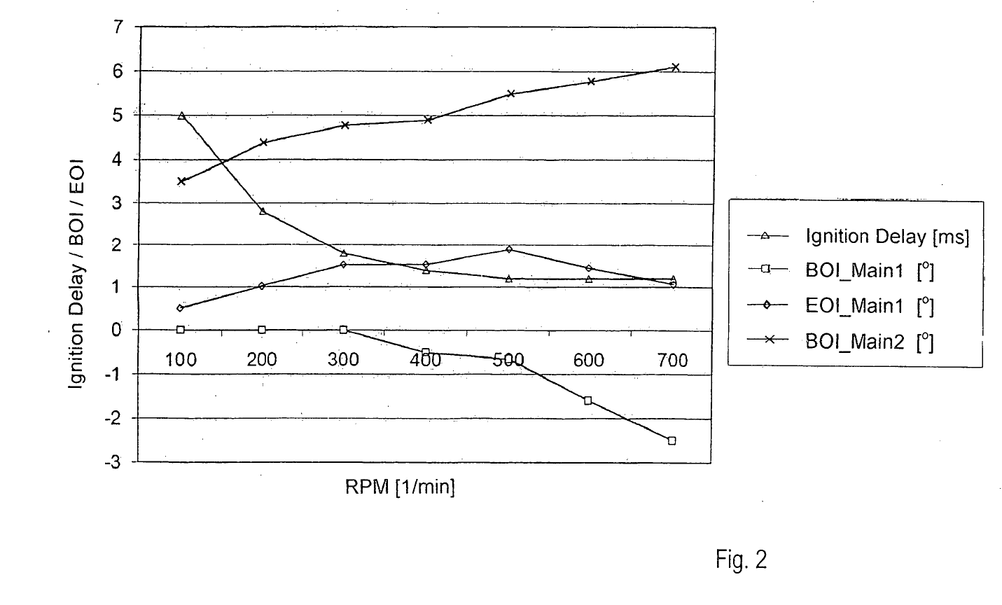

FIG. 2 shows variations of the injection start and the injection end of the first partial injection BOI_Main1, EOI_Main1, of the injection start of the second partial injection BOI_Main2 and measured ignition delays in dependence on the speed of the internal combustion engine in an exemplary manner. The injection start and the injection end of the partial injections and of the pre-injection are preferably adjusted in dependence on the speed of the internal combustion engine and on the outer temperature and/or an engine temperature. In this connection, it thereby has to be considered that the first partial injection Main1 should at the earliest take place when the pre-mixture reacts in a high temperature phase, otherwise there is a the danger that the combustion of the pre-mixture is extinguished by the first partial injection Main1. Due to the higher combustion chamber temperature at higher speeds, the pre-mixture reacts faster and it is possible to displace the injection start of the first partial injection BOI_Main1 with an increasing speed to early, that is, to a greater crankshaft angle before the upper dead center ZOT. The injection start of the second partial injection BOI_Main2 is displaced to late with increasing speed, that is, to a greater crankshaft angle after the upper dead center ZOT, so that a sufficient time span remains for the reaction of the mixture formed with the first partial injection.

With the method according to the invention, respectively only small fuel amounts are introduced into a combustion chamber in one or several pre-injections and in the first partial injections of the main injection. The temperature reduction caused by the starting evaporation is thereby small with the individual injections and the fuel air mixtures formed with the respectively injected fuel amounts ignite after a, comparatively short ignition delay. By means of the heat resulting during the combustion, not only the temperature reduction is compensated, but furthermore an increase of the combustion chamber temperature. A fuel amount injected subsequently correspondingly reacts faster and combusts after a shorter ignition delay than a fuel amount injected earlier. In this manner, large amounts of fuel can be injected into the combustion chamber in such a manner that the combustion chamber temperature is increased incrementally until a safe ignition of a larger fuel amount is finally possible at lower ambient temperatures.

What is claimed is:

1. A method for starting a self-igniting internal combustion engine at low temperatures, comprising the following steps:
a) injecting a first fuel amount into a combustion chamber of the internal combustion engine during a compression stroke of the internal combustion engine by means of pre-injection, and forming a partially homogenous pre-mixture in the combustion chamber;
b) injecting a main fuel amount into the combustion chamber by means of a main injection and combusting the fuel/air mixture by means of self-ignition,
c) selecting an injection start of the pre-injection such that the partially homogenous pre-mixture can be ignited after a very short ignition delay, if needed, and an injection start of the main injection such that the main fuel amount is injected into the combustion chamber during a combustion phase or directly after a combustion phase of the ignited pre-mixture, wherein the pre-injection is carried out in a region of between 22° and 100°, (in particular between 25° and 30° )of the crankshaft angle before an upper dead center position of the piston and the main injection takes place in a region between 20° of the crankshaft angle before the upper dead center and 20° of the crankshaft angle after the upper dead center position of the piston and, the main injection is divided into several partial injections, wherein a first partial injection occurs in a region between 2° of the crankshaft angle before the upper dead center and 2° after the upper dead center, and a second partial injection is carried out in a region between 2° and 5° of the crankshaft angle after the upper dead center position of the piston.

2. The method according to claim 1, wherein, with increasing engine speed, an injection start of the first partial injection is displaced in the direction toward early.

3. The method according to claim 1 wherein, with increasing speed, an injection start of a second and/or a later partial injection is displaced in the direction late.

4. The method according to claim 1, wherein, a fuel amount injected into a second or a later partial injection is larger than a fuel amount injected into a previous partial injection.

5. The method according to claim 1, wherein further pre-injections are carried out.

6. The method according to claim 1, wherein the sum of the fuel amounts injected during the pre-injections comprises between 5 and 20 weight percent of the entire fuel amount injected during a working cycle.

7. The method according to claim 1, wherein with increasing speed an injection start of the pre-injection is advanced.

8. The method according to claim 1, wherein the fuel injection is carried out by means of a common rail fuel injection system.

9. The method according to claim 8, wherein an injection pressure is adjusted during the starting process in dependence on the speed of the internal combustion engine.

10. The method according to claim 1, wherein an amount ratio between the main fuel amount and the sum of the partial fuel amounts injected during the pre-injections is adjusted in dependence on a speed and/or a temperature of the internal combustion engine.
